(19) United States
(12) Patent Application Publication
(10) Pub. No.: US 2014/0002540 A1
(43) Pub. Date: Jan. 2, 2014

(54) INKJET PRINTER WITH INK COLLECTION DEVICE

(71) Applicant: HON HAI PRECISION INDUSTRY CO., LTD., New Taipei (TW)

(72) Inventor: YU-JEN TSAO, New Taipei (TW)

(73) Assignee: HON HAI PRECISION INDUSTRY CO., LTD., New Taipei (TW)

(21) Appl. No.: 13/866,374

(22) Filed: Apr. 19, 2013

(30) Foreign Application Priority Data
Jun. 29, 2012 (TW) 101123433

(51) Int. Cl. B41J 29/17

(52) U.S. Cl. CPC B41J 29/17
USPC 347/25

(57) ABSTRACT

An inkjet printer includes a printer chassis, an inkjet head attached to the printer chassis, a belt connected to the inkjet head, a motor, and an ink collection device. The motor is secured to the printer chassis and meshes with the belt. The motor drives the belt in a first moving direction or a second moving direction to move the inkjet head back and forth. The ink collection device is secured to the printer chassis and includes a fan module driven for bringing undeposited ink particles generated in printing. The fan module is configured to be rotated by the belt in a single constant direction notwithstanding the direction of movement of the belt.

### BACKGROUND

1. Technical Field

The present disclosure relates to inkjet printers, more particularly to an inkjet printer with an ink collection device.

2. Description of Related Art

In an inkjet printer, many ink microparticles are generated in printing which are not deposited on the printing medium. If the ink particles are not collected in time, the inkjet particles accumulate on the components of the inkjet printer and contaminate the components.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an inkjet printer in accordance with an embodiment and shows an ink collection device disassembled from the inkjet printer.

FIG. 2 is an exploded, isometric view of the collecting device of FIG. 1.

FIG. 3 is an isometric view of the assembled collecting device of FIG. 2.

FIG. 4 is an isometric view of an assembled inkjet printer of FIG. 1.

FIG. 5 is an isometric, cutaway view of the assembled inkjet printer of FIG. 1.

FIG. 6 is an enlarged view of a circled portion VI of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

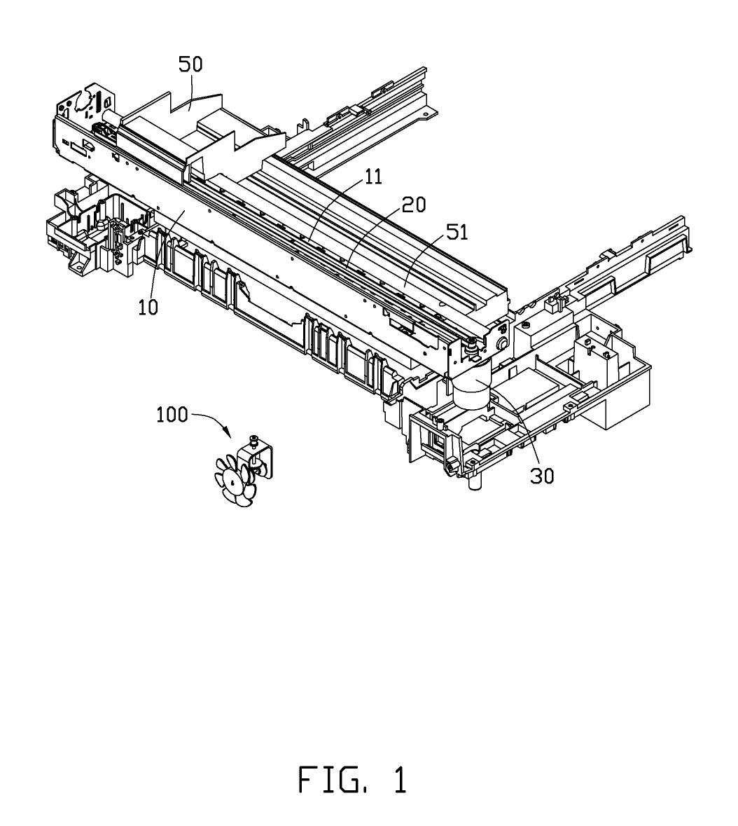

FIG. 1 illustrates an inkjet printer of an embodiment comprising a printer chassis 10, a belt 20 which is endless, a motor 30, an inkjet head 50, and an ink collection device 100. The motor 30 is secured to the printer chassis 10 to transmit the belt 20 in a first moving direction or a second moving direction reverse to the first moving direction. The inkjet head 50 is connected to the belt 20 and slidably attached to a sliding shaft 51, which is secured to the printer chassis 10. The inkjet head 50 slides forward or backward along the sliding shaft 51 as the belt 20 is moved in the moving direction or second moving direction. In the illustrated embodiment, only a part of the printer chassis 10 is shown.

The printer chassis 10 comprises a supporting plate 11 which supports the paper in printing. The supporting plate 11 defines a through hole (not shown). The belt 20 and the inkjet head 50 are located above the supporting plate 11, and the motor 30 is located below the supporting plate 11.

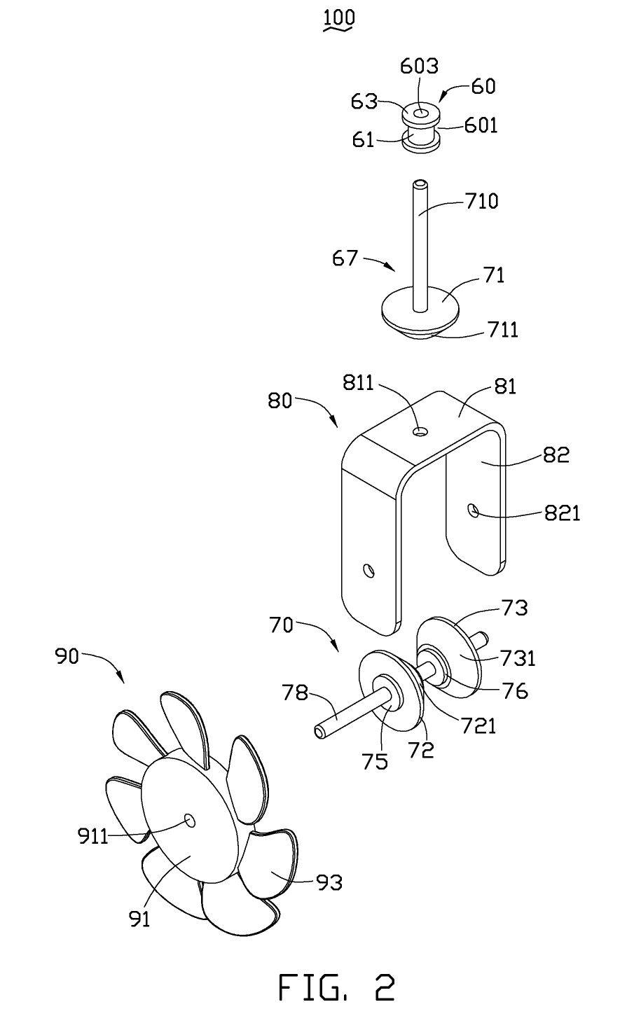

Referring to FIG. 2, the ink collection device 100 comprises a first rotating member 60, a second rotating member 67, a mounting member 80, a third rotating member 70, and a fan module 90.

The first rotating member 60 comprises a connecting portion 61 with two end portions 63 located at opposite end of the connecting portion 61. A diameter of the connecting portion 61 is less than that of each of the two end portions 63, thereby forming a ring slot 601 between the two end portions 63. The first rotating member 60 defines a securing hole 603 through the two end portions 63 and the connecting portion 61.

The second rotating member 67 comprises a first rotating shaft 710 and a first gear 71 secured to one end of a first rotating shaft 710. The first gear 71 comprises a first cone surface 711, and a plurality of first gear teeth is formed on the first cone surface 711.

The mounting member 80 comprises a first mounting piece 81 and two second mounting pieces 82 extending downward from opposite ends of the first mounting piece 81. The first mounting piece 81 defines a first mounting hole 811. Each of the two second mounting pieces 82 defines a second mounting hole 821. In an embodiment, the two second mounting pieces 82 are substantially perpendicular to the first mounting piece 81.

The third rotating member 70 comprises a second gear 72, a third gear 73, a first wheel 75, a second wheel 76, and a second rotating shaft 78. The first wheel 75 engages with second rotating shaft 78 and is secured to the second gear 72. The second wheel 76 engages with the second rotating shaft 78 and is secured to the third gear 73. The second gear 72 comprises a second cone surface 721, and the third gear 73 comprises a third cone surface 731. A plurality of second gear teeth is formed on the second cone surface 721 and a plurality of third gear teeth is formed on the third cone surface 731. In an embodiment, the first gear 71, the second gear 72 and the third gear 73 are bevel gears, for example.

The fan module 90 comprises a mounting portion 91 and a plurality of blades 93, which cause an airflow, secured to an outer perimeter of the mounting portion 91. An installing hole 911 is defined in the mounting portion 91.

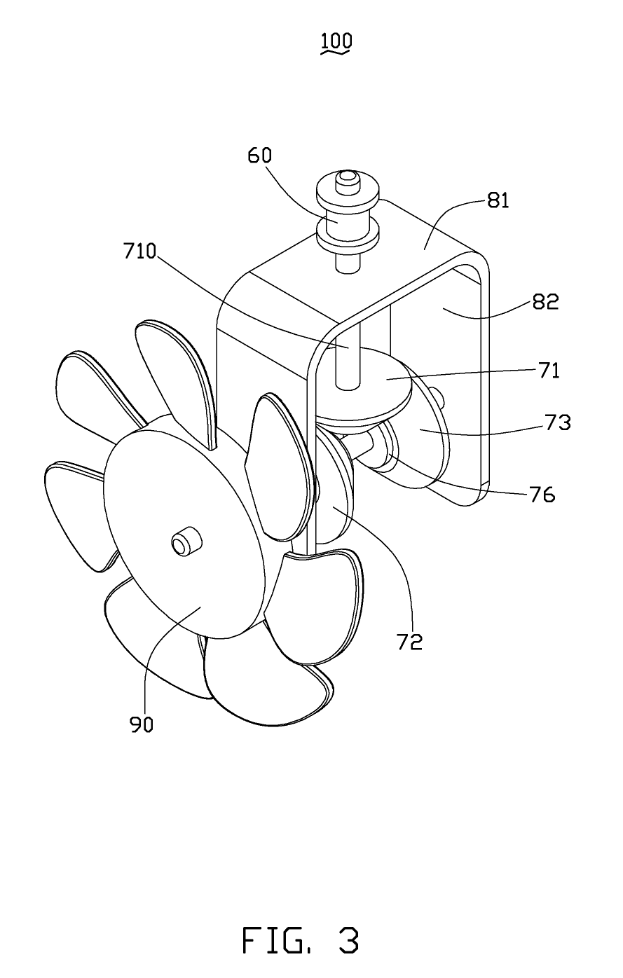

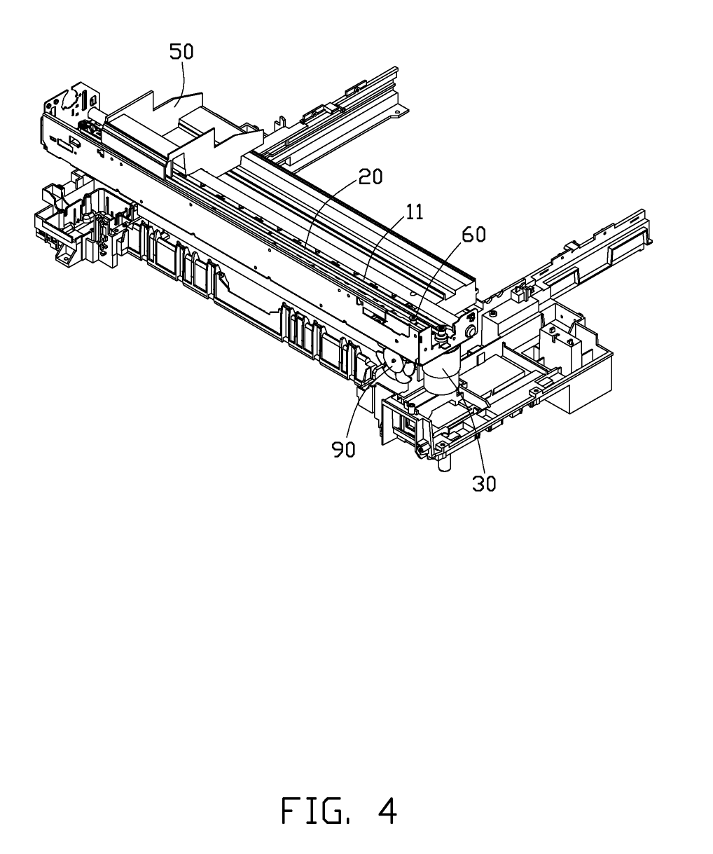

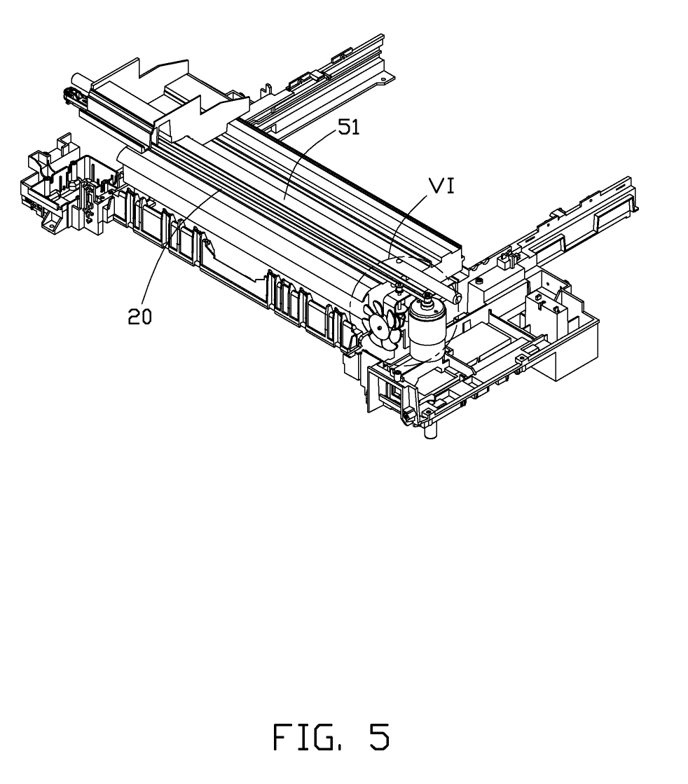

Referring to FIGS. 3-6, in assembly, the first rotating shaft 710 and the first gear 71 are placed between the two second mounting pieces 82. The first rotating shaft 710 extends through the first mounting hole 811. The second rotating shaft 78 is supported by the second mounting holes 821 of the second mounting piece 82. The first cone surface 711 of the first gear 71 meshes with the second cone surface 721 of the second gear 72 and the third cone surface 731 of the third gear 73 meshes with the first gear teeth, the second gear teeth, and the third gear teeth. The mounting member 80 is secured to a bottom surface of the supporting plate 11 by known means, such as by welding or screws. The first rotating shaft 710 extends through the through hole of the supporting plate 11. The first rotating member 60 is secured to one end of the first rotating shaft 710. The first rotating shaft 710 is substantially perpendicular to the second rotating shaft 78. The belt 20 is received in the ring slot 601 of the first rotating member 60 and abuts the outer perimeter of the connecting portion 61. One end of the second rotating shaft 78 is received in the installing hole 911 of the fan module 90, so the fan module 90 is secured to the second rotating shaft 78.

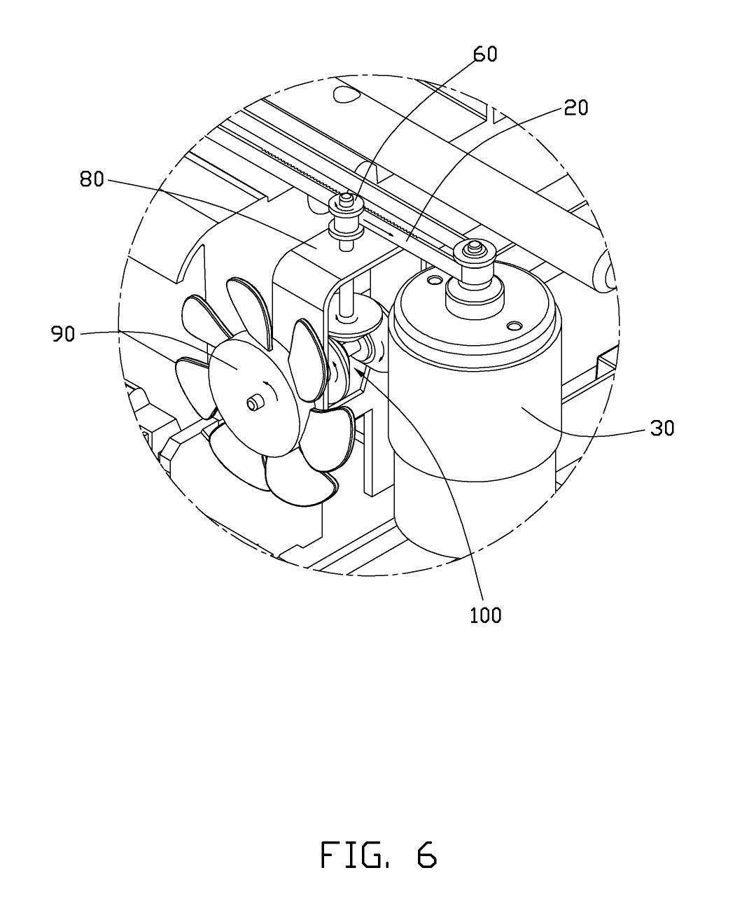

Referring to FIG. 6, when the motor 30 drives the belt 20 in the first moving direction (see arrow shown in FIG. 6), the inkjet head 50 is slid forward along the sliding shaft 51 and the first rotating member 60 is rotated in the first rotating direction. The first rotating shaft 710 and the first gear 71 of the second rotating member 67 are also rotated in the first rotating direction. The second gear 72 and the first wheel 75 are rotated in the second rotating direction, and the third gear 73 and the second wheel 76 are rotated in the first rotating direction, the second rotating shaft 78 is rotated by the first wheel 75, and not by the second wheel 76, in the second rotating direction. So, the fan module 90 is rotated in the second rotating direction. In an embodiment, the first rotating direction is a clockwise direction, and the second rotating direction is a counterclockwise direction.

When the motor 30 drives the belt 20 in the second moving direction, the inkjet head 50 is slid backward along the sliding shaft 51, and the first rotating member 60 is rotated in the second rotating direction. The first rotating shaft 710 and the first gear 71, of the second rotating member 67, are also rotated in the second rotating direction. The second gear 72 and the first wheel 75 are rotated in the first rotating direction, and the third gear 73 and the second wheel 76 are rotated in the second rotating direction. The second rotating shaft 78 is rotated by the second wheel 76, and not by the first wheel 75, in the second rotating direction. So, the fan module 90 is still rotated in second rotating direction.

As described above, the second rotating shaft 78 is rotated in the second rotating direction no matter the direction of rotation of the second gear 72 and the third gear 73.

In an embodiment, a wedge resilient piece (not shown) is located on each of the first wheel 75 and the second wheel 76, and two slots (not shown) are defined in the second rotating shaft 78 corresponding to the resilient pieces. When the first wheel 75 is rotated in the second rotating direction, the wedge resilient piece of the first wheel 75 is locked in the slot of the second rotating shaft 78, thereby rotating the second rotating shaft 78 in the second rotating direction. When the first wheel 75 is rotated in the first rotating direction, the wedge resilient piece cannot be locked in the slot of the second rotating shaft 78, so the first wheel 75 cannot rotate the second rotating shaft 78. Similarly, the second rotating shaft 78 is rotated by the second wheel 76 when the second wheel 76 is rotated in the first rotating direction, and cannot be rotated by the second wheel 76 when the second wheel 76 is rotated in the second rotating direction. The wedge resilient pieces and the slots can be replaced by other structures which have the same function.

As described above, whether the motor 30 drives the belt 20 in the first moving direction or in the second moving direction, the fan module 90 is still rotated in the second rotating direction. When the fan module 90 is rotated in the second rotating direction, any ink microparticles suspended in the air are gathered into the ink collection device 100.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An inkjet printer comprising:
a printer chassis; and
an inkjet head attached to the printer chassis;
a belt connected to the inkjet head;
a motor secured to the printer chassis and meshing with the belt, the motor configured to transmit the belt in a first moving direction or a second moving direction, reverse to the first moving direction, so as to move the inkjet head; and
an ink collection device secured to the printer chassis and comprising a fan module driven for bringing ink particles from the inkjet head generated in printing, and the fan module configured to be rotated by the belt in a constant direction when the belt is transmitted in a first rotating direction or in a second rotating direction.

2. The inkjet printer of claim 1, wherein the ink collection device further comprises a first rotating member meshing with the belt, a second rotating member secured to the first rotating member, and a third rotating member meshing with the second rotating member; and the fan module is secured to the third rotating member.

3. The inkjet printer of claim 2, wherein the first rotating member comprises a connecting portion and two end portions located opposite ends of the connecting portion; a diameter of the connecting portion is less than that of each of the two end portions; and the belt is located between the two end portions and meshes with the connecting portion.

4. The inkjet printer of claim 2, wherein the second rotating member comprises a first rotating shaft engaged with the first rotating member and a first gear secured to the first rotating member.

5. The inkjet printer of claim 4, wherein the third rotating member comprises a second rotating shaft secured to the fan module, a second gear secured to the second rotating shaft and meshing with the first gear, and a third gear secured to the second rotating shaft and meshing with the first gear; when the first gear is rotated in the second rotating direction, the second gear is rotated by the first gear and rotates the fan module in the constant direction by the second rotating shaft, and the third gear is rotated by the first gear reverse to the constant direction and doesn't rotate the second rotating shaft; and
when the first gear is rotated in the first rotating direction, the second gear is rotated by the first gear reverse to the constant direction and doesn't rotate the second rotating shaft, and the third gear is rotated by the first gear and rotates the fan module in the constant direction by the second rotating shaft.

6. The inkjet printer of claim 5, wherein the first rotating shaft is substantially perpendicular to the second rotating shaft.

7. The inkjet printer of claim 5, wherein each of the first gear, the second gear and the third gear is a bevel gear.

8. The inkjet printer of claim 5, wherein the ink collection device further comprises a mounting member secured to the printer chassis, the mounting member comprises a first mounting piece and two second mounting pieces located on the first mounting piece, the first rotating shaft is attached to the first mounting piece, and the second rotating shaft is attached to the two second mounting pieces.

9. The inkjet printer of claim 5, wherein the second gear and the third gear is located between the two second mounting pieces.

10. An inkjet printer comprising:
a printer chassis; and
an inkjet head attached to the printer chassis;
a belt connected to the inkjet head;
a motor secured to the printer chassis and meshing with the belt, the motor configured to transmit the belt in a first moving direction or a second moving direction reverse to the first moving direction, so as to slide the inkjet head; and
an ink collection device connected to the belt and comprising a fan module; the fan module rotated when the belt is transmitted for bringing ink particles from the inkjet head generated in printing, the fan module rotated in a constant direction when the belt is transmitted in a first rotating direction or in a second rotating direction.

11. The inkjet printer of claim 10, wherein the ink collection device further comprises a first rotating member meshing with the belt, a second rotating member secured to the first rotating member, and a third rotating member meshing with the second rotating member; and the fan module is secured to the third rotating member.

12. The inkjet printer of claim 11, wherein the first rotating member comprises a connecting portion and two end portions located opposite ends of the connecting portion; a diameter of the connecting portion is less than that of each of the two end portions; and the belt is located between the two end portions and meshes with the connecting portion.

13. The inkjet printer of claim 11, wherein the second rotating member comprises a first rotating shaft engaged with the first rotating member and a first gear secured to the first rotating member.

14. The inkjet printer of claim 13, wherein the third rotating member comprises a second rotating shaft secured to the fan module, a second gear secured to the second rotating shaft and meshing with the first gear, and a third gear secured to the second rotating shaft and meshing with the first gear; when the first gear is rotated in the second rotating direction, the second gear is rotated by the first gear and rotates the fan module in the constant direction by the second rotating shaft, and the third gear is rotated by the first gear reverse to the constant direction and doesn't rotate the second rotating shaft; and when the first gear is rotated in the first rotting direction, the second gear is rotated by the first gear reverse to the constant direction and doesn't rotate the second rotating shaft, and the third gear is rotated by the first gear and rotates the fan module in the constant direction by the second rotating shaft.

15. The inkjet printer of claim 14, wherein the first rotating shaft is substantially perpendicular to the second rotating shaft.

16. The inkjet printer of claim 14, wherein each of the first gear, the second gear and the third gear is a bevel gear.

17. The inkjet printer of claim 14, wherein the ink collection device further comprises a mounting member secured to the printer chassis, the mounting member comprises a first mounting piece and two second mounting pieces located on the first mounting piece, the first rotating shaft is attached to the first mounting piece, and the second rotating shaft is attached to the two second mounting pieces.

18. The inkjet printer of claim 14, wherein the second gear and the third gear is located between the two second mounting pieces.
